(19) United States
(12) Patent Application Publication
(10) Pub. No.: US 2014/0369254 A1
(43) Pub. Date: Dec. 18, 2014

(54) Amplified Bonded Cellular Broadband Internet Access Device

(71) Applicant: Harold E. McGowen, IV, Bullard, TX (US)

(72) Inventor: Harold E. McGowen, IV, Bullard, TX (US)

(21) Appl. No.: 14/302,948

(22) Filed: Jun. 12, 2014

Related U.S. Application Data
(60) Provisional application No. 61/834,051, filed on Jun. 12, 2013.

(51) Int. Cl. H04W 16/26

(52) U.S. Cl. CPC H04W 16/26
USPC 370/315

(57) ABSTRACT

An amplified bonded cellular broadband internet access device allows for the reception of radio frequency (RF) signals in remote locations from a cell tower or similar structure and for the amplification and bonding of said signals in order to provide internet access and voice communications. An antenna receives said RF signals and directs the RF signals to a signal amplification unit, which generates amplified RF signals. The amplified RF signals are then passed through a signal bonding unit, where the amplified RF signals are divided using a bonding splitter, encoded through a plurality of internet service provider modems, and bonded together through a broadband bonding network device to create bonded signals. A signal distribution interface including a plurality of ports and a distribution transceiver then directs the bonded signals across a local area network or wide area network.

The current application claims a priority to the U.S. Provisional Patent application Ser. No. 61/834,051 filed on Jun. 12, 2013.

### FIELD OF THE INVENTION

The present invention relates generally to signal amplification and bonding. More specifically, the present invention is an apparatus for receiving radio frequency signals transmitted from cell towers and then amplifying and bonding said signals in order to provide internet access and phone service in remote areas.

### BACKGROUND OF THE INVENTION

In recent years, in most remote, rural, and largely unpopulated areas of the country, such as oil fields and gas fields, an essential part of operational control, equipment monitoring, and crew coordination is done through data communication. For instance, an offshore oil and gas drilling/production platform or an onshore oil and gas drilling, completion, or production operation can be better managed through constant communication with Web-based/Internet communication. Creating communication means for such remote operations and facilities provides the ability to instrument and link these facilities at remote sites with regional offices and headquarters. Personal computers, supervisory control and data acquisition (SCADA), smart-phones, tablet computing, digital video, and other information technology is being used to drive efficiency and bring new levels of collaboration to these remote operations and facilities. Real-time Web-based/Internet communication has played a major role in these efficiency improvements and is projected to play an even greater role in the future. With more reliance on web-based communication, remote facilities become vulnerable to connection loss and drops in data transmission speed. Internet access is increasingly becoming a mission critical requirement. These remote operational facilities therefore can greatly benefit from better, faster, and more reliable Internet access.

The currently available data communication services have yet to meet the growing demand for high speed internet and quality voice communications in remote areas. The scarcity of cellular network towers in many remote areas creates cellular connection viability and reliability issues and reduces data transmission speeds. Satellite data transmission systems do not function in some areas, provide limited bandwidth, are subject to disruption by the weather, are vulnerable to ground-station conditions, and are subject to latency issues where latency is defined as the amount of delay, measured in milliseconds, that occurs in a round-trip data transmission. Applications such as Voice Over IP (VoIP), Video Conferencing, Cloud-based Computing, and Remote Access Software that offers access to a remote computer from any computer with an internet (such as Citrix GoToMyPC) are often negatively affected by connection reliability, limited band-width, and latency issues. Latency degrades VoIP phone conversations due to overlapping noises, one speaker interrupting the other, echo, and disruption of synchronization between voice and other data types (especially during video conferencing) and other issues. Some end users and service providers have developed custom dedicated systems specific to certain industrial, oil and gas, and other operations located in remote locations in order to address these issues. Such custom systems based on proprietary networks tend to require large capital investments to deploy and take significant lead time to install, test and fully implement. These proprietary networks require long distance cabling and/or sophisticated wireless or optical data transmission hardware and complex network structuring. Due to the current presence of cellular network towers, albeit sparse, in most rural/remote areas, that provide broad public access to 3G networks, and the continuous roll-out of 4G+ systems throughout these networks, there is a great opportunity to leverage the existing cellular network to provide data communication and web access to remote locations, provided that the obstacles of sparse cellular network towers (often distant from operations/work-sites in rural and remote areas), poor cellular modem reliability, and low bandwidth can be overcome.

Therefore it is an object of the present invention to provide a novel apparatus that, in one device, receives and transmits cellular signals, boosts those signals, and combines those signals through redundant or parallel data communication devices, in order to provide high speed, low latency, and high reliability internet access for remote operations and facilities at a relatively low cost. The present invention can produce a wired or Wi-Fi data connection and an amplified cellular signal that can be transmitted throughout an entire remote location/facility. Said improved communications capability and internet coverage has the potential to enhance operational control, improve decision making, and reduce capital expenditures and operating costs at remote locations/facilities.

### BRIEF DESCRIPTION OF THE DRAWINGS

FIG. 1 is a diagram detailing the electronic connections in the preferred embodiment of the present invention.

FIG. 2 is a diagram detailing the electrical connections of the present invention.

FIG. 3 is a diagram detailing the electronic connections of the present invention, wherein the signal amplifying unit is wirelessly connected to the signal bonding unit.

FIG. 4 is a diagram depicting the bonding transceiver, the bonding splitter, the plurality of ISP modems, and the broadband bonding network device being positioned within the faraday cage.

FIG. 5 is a diagram detailing the electronic connections of the present invention, wherein the signal amplifying unit is wired to the signal bonding unit and comprises a low pass amplifier and a high pass amplifier.

FIG. 6 is a diagram detailing the electronic connections of the present invention, wherein the signal amplifying unit is wirelessly connected to the signal bonding unit and comprises the low pass amplifier and the high pass amplifier.

FIG. 7 is a diagram depicting the cellular carrier transceiver being wirelessly connected to the amplifier transceiver, wherein the amplifier transceiver is electronically connected to either the single amplifier or the second amplifier splitter;

FIG. 8 is a diagram thereof, wherein a phone jack is electronically connected to the cellular carrier transceiver and a handset is electronically connected to the phone jack.

FIG. 9 is a diagram depicting the cellular carrier transceiver being wired to the signal amplifying unit, wherein the cellular carrier transceiver is electronically connected to either the single amplifier or the second amplifier splitter.

FIG. 10 is a diagram depicting the phone jack being wired to the signal amplifying unit, wherein the phone jack is electronically connected to either the single amplifier or the second amplifier splitter.

### DETAIL DESCRIPTIONS OF THE INVENTION

All illustrations of the drawings are for the purpose of describing selected versions of the present invention and are not intended to limit the scope of the present invention.

The present invention is an amplified bonded cellular broadband internet access device. The present invention allows for the reception of radio frequency (RF) signals in remote locations from a cell tower or similar structure and for the amplification and bonding of said signals in order to provide internet access and voice communications. The present invention allows for the bonding RF signals processed through multiple internet service provider (ISP) modems in order to increase the overall bandwidth of bonded signals versus un-bonded signals.

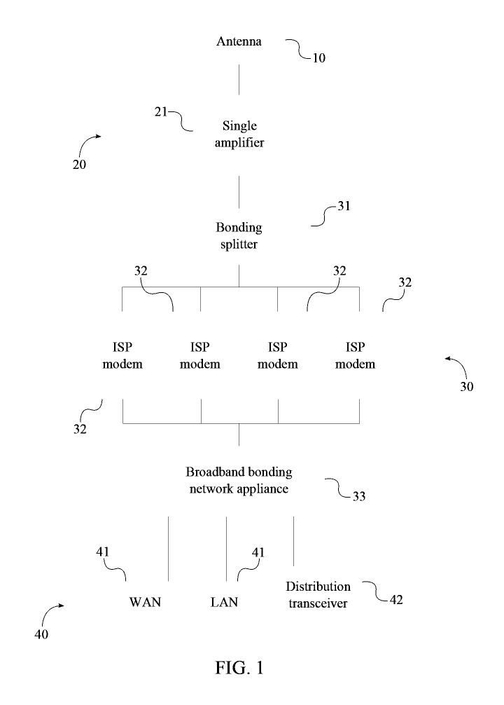

In reference to FIG. 1, the present invention comprises an antenna 10, a signal amplifying unit 20, a signal bonding unit 30, and a signal distribution interface 40. The antenna 10 receives the RF signals from cell towers or similar RF signal distribution units and relays the RF signals to the signal amplifying unit 20. As such, the signal amplifying unit 20 is electronically connected to the antenna 10, preferably through a coaxial cable, although any connection type can be used. It is also possible for multiple antennas to be used, in which case a combiner would be used to join the RF signals and deliver the RF signals to the signal amplifying unit 20.

In further reference to FIG. 1, the signal bonding unit 30 is communicably coupled to the signal amplifying unit 20 and comprises a bonding splitter 31, a plurality of ISP modems 32, and a broadband bonding network device 33. The signal bonding unit 30 can be communicably coupled to the signal amplifying unit 20 through a wired or wireless connection. In the case of a wireless connection, the signal bonding unit 30 further comprises a bonding transceiver 34 and the signal amplifying unit 20 comprises an amplifier transceiver 22. The plurality of ISP modems 32 are electronically connected to both the bonding splitter 31 and the broadband bonding network device 33. The signal distribution interface 40 is then electronically connected to the broadband bonding network device 33.

In the preferred embodiment of the present invention, the signal amplifying unit 20 is hardwired to the signal bonding unit 30, wherein the bonding splitter 31 is electronically connected to the signal amplifying unit 20 through a coaxial cable or similar means. The signal amplifying unit 20 comprises a single amplifier 21 that is electronically connected to both the antenna 10 and the bonding splitter 31, wherein the singe amplifier is bidirectional. The RF signals received by the antenna 10 are passed through the single amplifier 21, which acts to increase the strength of the RF signals, compensate for decibel loss, and improve the range of the RF signals. The amplified RF signals are then passed through the bonding splitter 31 to the plurality of ISP modems 32.

Each of the plurality of ISP modems 32 corresponds to a unique ISP, wherein each of the plurality of ISP modems 32 is operated over a specific frequency or frequencies. The bonding splitter 31 separates the amplified signal into a plurality of amplified signals, wherein the plurality of amplified signals is distributed one-to-one amongst the plurality of ISP modems 32. Each of the plurality of ISP modems 32 modulates and encodes the amplified signal into a digital information signal that is capable of being transmitted to and received by fixed or mobile applications, such as a remote computer or cell phone. Additionally, each of the plurality of ISP modems 32 is capable of decoding signals received from said fixed or mobile applications. The encoded signal from each of the plurality of ISP modems 32 is then directed to the broadband bonding network device 33.

In the preferred embodiment of the present invention, each of the plurality of ISP modems 32 is connected to the broadband bonding network device 33 using a universal serial bus (USB) connector, however, it is possible for any other type of connection to be used. The broadband bonding network device 33 receives the encoded signal from each of the plurality of ISP modems 32 and combines the encoded signal from each of the plurality of ISP modems 32 into a single encoded signal. The process of combining the encoded signal from each of the plurality of ISP modem provides greater redundancy and bandwidth of the single encoded signal. The broadband bonding network device 33 controls the data traffic from the plurality of ISP modems 32 in such a way that if one of the plurality of ISP modems 32 fails, then the data traffic is redistributed among the remaining ISP modems, such that the end user distribution is uninterrupted.

The single encoded signal is then sent to the signal distribution interface 40, wherein the signal distribution interface 40 provides a means for distributing the single encoded signal to electronic devices. The single encoded signal can be sent from the signal distribution interface 40 to the electronic devices using either a wired or wireless connection, and as such the signal distribution interface 40 may comprise a plurality of ports 41 and/or a distribution transceiver 42. The plurality of ports 41 is electronically connected to the broadband bonding network device 33 and can provide various wired connection types for connecting equipment required for a local area network (LAN) or wide area network (WAN). Similarly, the distribution transceiver 42 is electronically connected to the broadband bonding network device 33 and can be communicably coupled to equipment in a LAN or WAN.

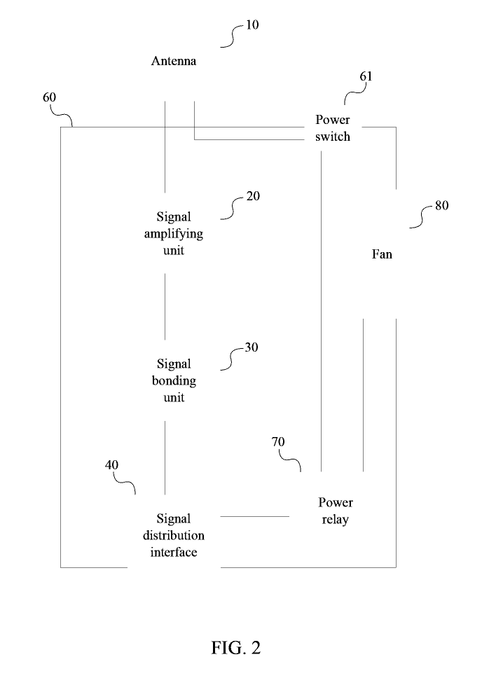

In reference to FIG. 2, in the preferred embodiment of the present invention, the signal amplifying unit 20, the signal bonding unit 30, and the signal distribution interface 40 are mounted within a housing 60, along with a power relay 70. The power relay 70 can be connected to an external power source, such as an outlet, or an internal power source, such as a battery. The power relay 70 is electrically connected to the antenna 10, the signal amplifying unit 20, the signal bonding unit 30, and the signal distribution interface 40. Through a power switch 61 positioned about the housing 60, the power relay 70 can be toggled to supply current to the antenna 10, the signal amplifying unit 20, the signal bonding unit 30, and the signal distribution interface 40.

In further reference to FIG. 2, as is common with electrical devices, the components positioned within the housing 60 may produce excess heat, especially when operated for extended periods of time. The excess heat within the housing 60 can damage said components, leading to decreased performance, efficiency, and durability. As such, the housing 60 may comprise a fan 80 that is electrically connected to the power relay 70. The fan 80 can be directed to pull in cool air outside of the housing 60 or to expel hot air within the housing 60 in order to mitigate the heat within the housing 60 and prevent the signal amplifying unit 20, signal bonding unit 30, or signal distribution interface 40 from overheating. Additionally, it is possible for multiple fans to be used.

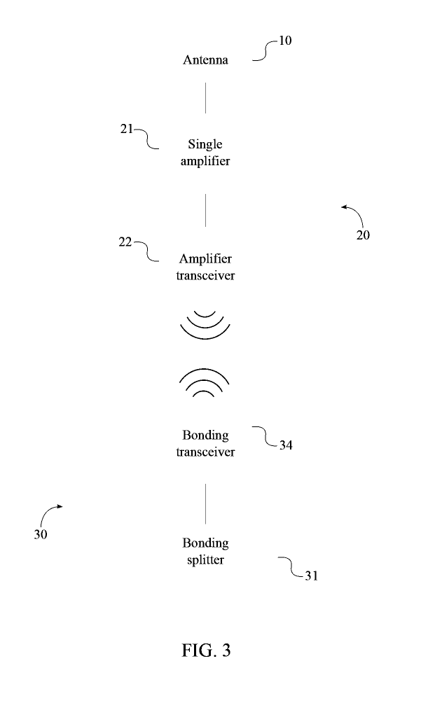

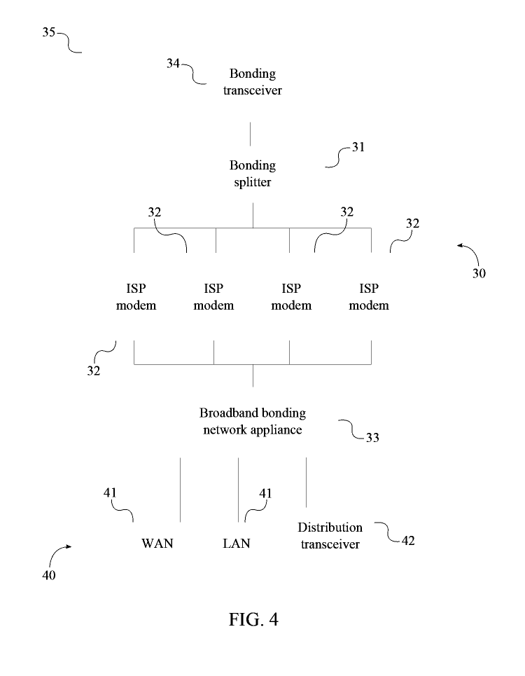

In reference to FIG. 3, in an alternative embodiment of the present invention, the signal amplifying unit 20 is wirelessly connected to the signal bonding unit 30, wherein the amplifier transceiver 22 is communicably coupled to the bonding transceiver 34. The bonding transceiver 34 is electronically connected to the bonding splitter 31 through a coaxial cable or similar means, such that the amplified signal is sent from the amplifier transceiver 22, received by the bonding transceiver 34, and then dispersed to the plurality of ISP modems 32 through the bonding splitter 31. Additionally, the signal bonding unit 30 further comprises a faraday cage 35, wherein the bonding transceiver 34, the bonding splitter 31, the plurality of ISP modems 32, and the broadband bonding network device 33 are positioned within the faraday cage 35, as depicted in FIG. 4. The faraday cage 35 acts to block RF signals outside the housing 60 that could interfere with the RF signals operated by cellular carriers within the housing 60.

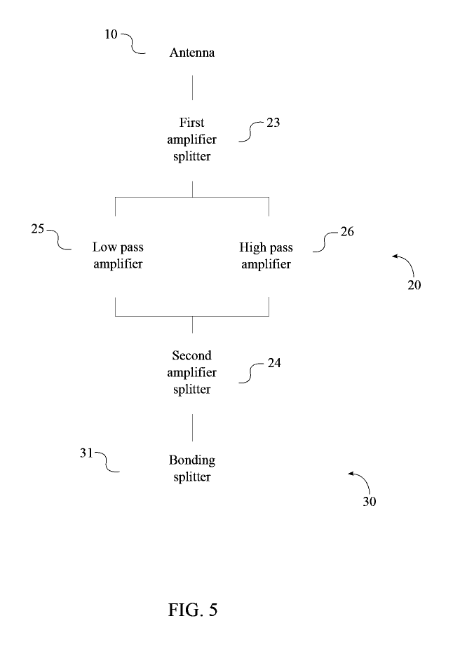

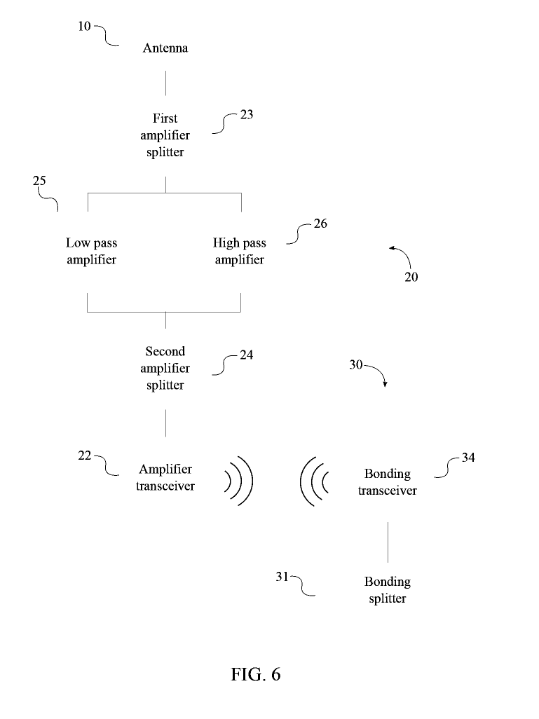

In an alternative embodiment of the signal amplifying unit 20, the signal amplifying unit 20 comprises a first amplifier splitter 23, a second amplifier splitter 24, a low pass amplifier 25, and a high pass amplifier 26, as depicted in FIG. 5-6. The low pass amplifier 25 and the high pass amplifier 26 are electronically connected to both the first amplifier splitter 23 and the second amplifier splitter 24. The first amplifier splitter 23 is also electronically connected to the antenna 10, while the second amplifier splitter 24 is communicably coupled to the signal bonding unit 30. More specifically, the second amplifier splitter 24 is electronically connected to the bonding splitter 31 if the signal amplifying unit 20 and signal bonding unit 30 connection is wired, as shown in FIG. 5, or electronically connected to the amplifier transceiver 22 if the signal amplifying unit 20 and the signal bonding unit 30 connection is wireless, as shown in FIG. 6.

RF signals are received by the antenna 10 and are split and directed to both the low pass amplifier 25 and the high pass amplifier 26. The low pass amplifier 25 is bidirectional, and acts to filter out low frequency signals within a designated range of frequencies, and then amplify said low frequency signals. Similarly, the high pass is bidirectional, and acts to filter out high frequency signals within a designated range of frequencies, and then amplify said high frequency signals. Once, filtered and amplified, the RF signals are passed through the second amplifier splitter 24 and merged into a single amplified signal.

The present invention may also comprise a voice communications terminal 50. The voice communications terminal 50 is used for providing voice communications through either fixed handsets or cellular devices in remote locations. The voice communications terminal 50 is communicably coupled to the signal amplifying unit 20 through either a wired or wireless connection. Depending on the desired embodiment, the voice communications terminal 50 may comprise a cellular carrier transceiver 51 or a phone jack 52.

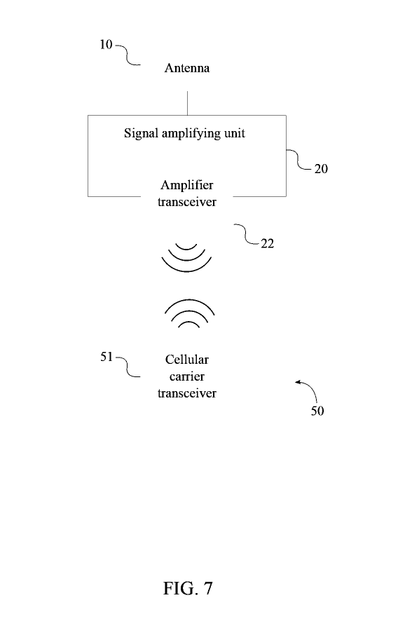

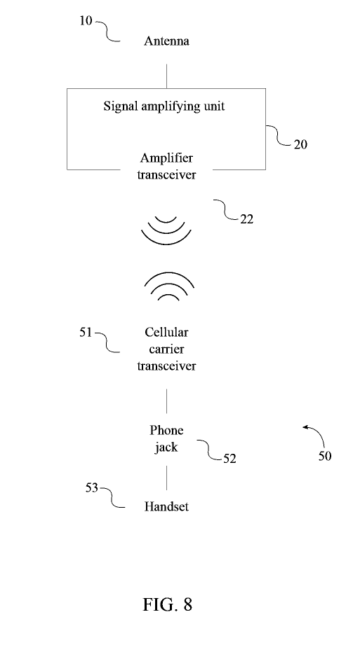

In reference to FIG. 7-8, if the voice communications terminal 50 is wirelessly coupled to the signal amplifying unit 20, then the cellular carrier transceiver 51 is communicably coupled to the amplifier transceiver 22. The RF signals operated by cellular carriers are amplified and then transmitted to the cellular carrier transceiver 51. The cellular carrier transceiver 51 can then transmit the amplified RF signals to cellular devices or to a handset 53 through the phone jack 52, wherein the phone jack 52 is electronically connected to the cellular carrier transceiver 51.

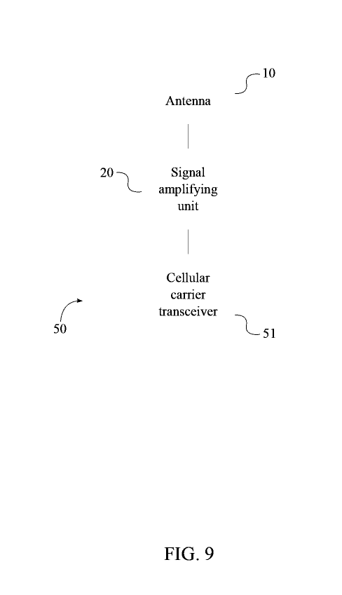

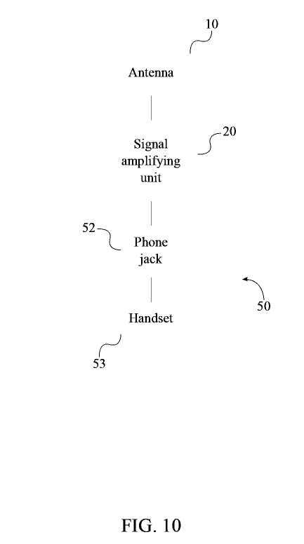

In reference to FIG. 9-10, if the voice communications terminal 50 is wired to the signal amplifying unit 20, then the voice communications terminal 50 is electronically connected to the signal amplifying unit 20. For distribution to cellular devices, the cellular carrier transceiver 51 is electronically connected to the signal amplifying unit 20. More specifically, the cellular carrier transceiver 51 is electronically connected to either the single amplifier 21 or the second amplifier splitter 24. For distribution through a handset 53, the phone jack 52 is electronically connected to the signal amplifying unit 20. More specifically, the phone jack 52 is electronically connected to either the single amplifier 21 or the second amplifier splitter 24.

Although the invention has been explained in relation to its preferred embodiment, it is to be understood that many other possible modifications and variations can be made without departing from the spirit and scope of the invention as hereinafter claimed.

What is claimed is:

1. An amplified bonded cellular broadband internet access device:
an antenna;
a signal amplifying unit;
a signal bonding unit;
a signal distribution interface;
the signal bonding unit comprise a bonding splitter, a plurality of internet service provider (ISP) modems, and a broadband bonding network device;
the signal amplifying unit being electronically connected to the antenna;
the signal bonding unit being communicably coupled to the signal amplifying unit;
the signal distribution interface being electronically connected to the signal bonding unit; and
the plurality of ISP modems being electronically connected to the bonding splitter and the broadband bonding network device.

2. The amplified bonded cellular broadband internet access device as claimed in claim 1 comprises:
the bonding splitter being electronically connected to the signal amplifying unit.

3. The amplified bonded cellular broadband internet access device as claimed in claim 1 comprises:
the signal amplifying unit comprises an amplifier transceiver;
the signal bonding unit further comprises a bonding transceiver;
the bonding transceiver being electronically connected to the bonding splitter; and
the bonding transceiver being communicably coupled to the amplifier transceiver.

4. The amplified bonded cellular broadband internet access device as claimed in claim 1 comprises:
the signal amplifying unit comprises a first amplifier splitter, a second amplifier splitter, a low pass amplifier, and a high pass amplifier;
the first amplifier splitter being electronically connected to the antenna;
the low pass amplifier and the high pass amplifier being electronically connected to the first amplifier splitter;
the low pass amplifier and the high pass amplifier being electronically connected to the second amplifier splitter; and
the second amplifier splitter being communicably coupled to the signal bonding unit.

5. The amplified bonded cellular broadband internet access device as claimed in claim 1 comprises:
the signal bonding unit further comprises a bonding transceiver and a faraday cage;
the bonding transceiver being electronically connected to the bonding splitter; and
the bonding transceiver, the bonding splitter, the plurality of ISP modems, and the broadband bonding network device being positioned in the faraday cage.

6. The amplified bonded cellular broadband internet access device as claimed in claim 1 comprises:
a voice communications terminal;
the voice communications terminal comprises a cellular carrier transceiver; and
the cellular carrier transceiver being electronically connected to the signal amplifying unit.

7. The amplified bonded cellular broadband internet access device as claimed in claim 1 comprises:
a voice communications terminal;
the signal amplifying unit comprises an amplifier transceiver;
the voice communications terminal comprises a cellular carrier transceiver; and
the cellular carrier transceiver being communicably coupled to the amplifier transceiver.

8. The amplified bonded cellular broadband internet access device as claimed in claim 1 comprises:
a voice communications terminal;
the signal amplifying unit comprises an amplifier transceiver;
the voice communications terminal comprises a cellular carrier transceiver and a phone jack;
the cellular carrier transceiver being communicably coupled to the amplifier transceiver; and
the phone jack being electronically connected to the cellular carrier transceiver.

9. The amplified bonded cellular broadband internet access device as claimed in claim 1 comprises:
a voice communications terminal;
the voice communications terminal comprises a phone jack; and
the phone jack being electronically connected to the signal amplifying unit.

10. The amplified bonded cellular broadband internet access device as claimed in claim 1 comprises:
the signal distribution interface comprises a plurality of ports; and
the plurality of ports being electronically connected to the broadband bonding network device.

11. The amplified bonded cellular broadband internet access device as claimed in claim 1 comprises:
the signal distribution interface comprises a distribution transceiver; and
the distribution transceiver being electronically connected to the broadband bonding network device.

12. An amplified bonded cellular broadband internet access device:
an antenna;
a signal amplifying unit;
a signal bonding unit;
a signal distribution interface;
the signal bonding unit comprise a bonding splitter, a plurality of internet service provider (ISP) modems, and a broadband bonding network device;
the signal distribution interface comprises a plurality of ports and a distribution transceiver;
the signal amplifying unit being electronically connected to the antenna;
the bonding splitter being electronically connected to the signal amplifying unit;
the plurality of ISP modems being electronically connected to the bonding splitter and the broadband bonding network device; and
the plurality of ports and the distribution transceiver being electronically connected to the broadband bonding network device.

13. The amplified bonded cellular broadband internet access device as claimed in claim 12 comprises:
the signal amplifying unit comprises a first amplifier splitter, a second amplifier splitter, a low pass amplifier, and a high pass amplifier;
the first amplifier splitter being electronically connected to the antenna;
the low pass amplifier and the high pass amplifier being electronically connected to the first amplifier splitter;
the low pass amplifier and the high pass amplifier being electronically connected to the second amplifier splitter; and
the second amplifier splitter being communicably coupled to the signal bonding unit.

14. The amplified bonded cellular broadband internet access device as claimed in claim 12 comprises:
a voice communications terminal;
the voice communications terminal comprises a cellular carrier transceiver; and
the cellular carrier transceiver being electronically connected to the signal amplifying unit.

15. The amplified bonded cellular broadband internet access device as claimed in claim 12 comprises:
a voice communications terminal;
the voice communications terminal comprises a phone jack; and
the phone jack being electronically connected to the signal amplifying unit.

16. An amplified bonded cellular broadband internet access device:
an antenna;
a signal amplifying unit;
a signal bonding unit;
a signal distribution interface;
the signal amplifying unit comprises an amplifier transceiver;
the signal bonding unit comprise a bonding splitter, a plurality of internet service provider (ISP) modems, a broadband bonding network device, a faraday cage, and a bonding transceiver;
the signal distribution interface comprises a plurality of ports and a distribution transceiver;
the signal amplifying unit being electronically connected to the antenna;
the signal bonding unit being communicably coupled to the signal amplifying unit;
the bonding transceiver being communicably coupled to the amplifier transceiver;
the bonding transceiver being electronically connected to the bonding splitter;
the plurality of ISP modems being electronically connected to the bonding splitter and the broadband bonding network device;
the bonding transceiver, the bonding splitter, the plurality of ISP modems, and the broadband bonding network device being positioned in the faraday cage; and
the plurality of ports and the distribution transceiver being electronically connected to the broadband bonding network device.

17. The amplified bonded cellular broadband internet access device as claimed in claim 16 comprises:
the signal amplifying unit further comprises a first amplifier splitter, a second amplifier splitter, a low pass amplifier, and a high pass amplifier;
the first amplifier splitter being electronically connected to the antenna;
the low pass amplifier and the high pass amplifier being electronically connected to the first amplifier splitter;
the low pass amplifier and the high pass amplifier being electronically connected to the second amplifier splitter; and
the second amplifier splitter being communicably coupled to the signal bonding unit.

18. The amplified bonded cellular broadband internet access device as claimed in claim 16 comprises:
a voice communications terminal;
the voice communications terminal comprises a cellular carrier transceiver; and
the cellular carrier transceiver being communicably coupled to the amplifier transceiver.

19. The amplified bonded cellular broadband internet access device as claimed in claim 16 comprises:
a voice communications terminal;
the voice communications terminal comprises a cellular carrier transceiver and a phone jack;
the cellular carrier transceiver being communicably coupled to the amplifier transceiver; and
the phone jack being electronically connected to the cellular carrier transceiver.
